(19) United States
(12) Patent Application Publication
(10) Pub. No.: US 2009/0250034 A1
(43) Pub. Date: Oct. 8, 2009

(54) Structural member of an internal combustion engine operated with alcoholic fuel

(75) Inventors: Helmut Engelhardt, Herzogenaurach (DE); Oliver Schnell, Veitsbronn (DE)

Correspondence Address: HEDMAN & COSTIGAN P.C., 1185 AVENUE OF THE AMERICAS, NEW YORK, NY, 10036, US

(73) Assignee: SCHAEFFLER KG

(21) Appl. No.: 12/384,051

(22) Filed: Mar. 31, 2009

(30) Foreign Application Priority Data
Apr. 3, 2008 (DE) 102008017023.2

(51) Int. Cl. F02F 7/00

(52) U.S. Cl. 123/195 R

(57) ABSTRACT

A structural member comprised of at least one component for an internal combustion piston engine operated with alcoholic fuel, at least one of the components being made of a martensitic steel with a C content of up to 0.7% and a Cr content of 12 to 18% wherein in an installed state of the structural member in the internal combustion engine, the at least one component is directly exposed to the lubricating oil serving to lubricate a crank mechanism of the internal combustion engine.

### FIELD OF THE INVENTION

The invention relates to a structural member comprised of one or more components for an internal combustion piston engine operated with alcoholic fuel, at least one of the components being made of a martensitic steel with a C content of up to 0.7% and a Cr content of 12 to 18%.

### BACKGROUND OF THE INVENTION

The increasing shortage of crude oil and the growing endeavor to reduce emission of climate-relevant carbon dioxide are increasingly compelling reasons to mix alcohols into crude oil-based fuels for internal combustion piston engines, or to substitute them completely with these. As well-known, a typical example of such an alcoholic fuel is the fuel blend designated as E85 comprising 85% ethanol and 15% gasoline, whereas purely alcoholic fuels like E100 and M100, for example, consist respectively of 100% ethanol and 100% methanol.

In the structural designing of internal combustion engines operated with alcoholic fuels, however, it is imperative to pay heed to the chemical aggressiveness of such fuels that can not only lead to a premature destruction of elastomer seals but also to corrosion in the metallic components. In this connection, it is known from the document JP 06058218, considered as generic in the art, to make the valve body and/or the valve seat of a fuel injection valve, adapted for use with alcoholic fuels, out of a martensitic steel of the pre-cited type. It is not only the high corrosion resistance but, as a result of the martensitic microstructure, also the high wear resistance that predestinates such a steel to be used as a durably strong base material for fuel-conducting structural members or their components that are subjected on the one hand to high mechanical and tribological loads and, on the other hand, to the corrosive properties of alcoholic fuel.

### OBJECTS OF THE INVENTION

Starting from the cited prior art, it is an object of the present invention, with a view to an integral overall structural concept of an internal combustion piston engine operated with alcoholic fuel, to provide both wear and corrosion resistant structural members or components thereof that are arranged outside of the fuel system in the internal combustion engine.

This and other objects and advantages of the invention will become obvious from the following detailed description.

### SUMMARY OF THE INVENTION

The invention achieves the above objects by the fact that, in an installed state of the structural member in the internal combustion engine, the structural member or, if this is made up of a plurality of components, at least one of the components is directly exposed to the lubricating oil serving to lubricate a crank mechanism of the internal combustion engine. This solution pays due heed to the corrosive properties of the water fraction formed during the blow-by-gas combustion of alcoholic fuels and the likewise high alcohol charge in the lubricating oil in comparison with the combustion of conventional fuels based solely on crude oil.

The following table gives an overview of suitable martensitic steels preferably used as base material for the structural members and components:

| Material | | C content | Cr content |
|---|---|---|---|
| No. [DIN] | Material type | [%] | [%] |
| 1.3541 | X45Cr13 | 0.42-0.50 | 12.50-14.50 |
| 1.4005 | X12CrS13 | max. 0.15 | 12.00-13.00 |
| 1.4006 | X10Cr13/X12Cr13 | 0.03-0.12 | 12.00-14.00 |
| 1.4021 | X20Cr13 | 0.17-0.25 | 12.00-14.00 |
| 1.4024 | X15Cr13 | 0.12-0.17 | 12.00-14.00 |
| 1.4028 | X30Cr13 | 0.28-0.35 | 12.00-14.00 |
| 1.4034 | X46Cr13 | 0.42-0.50 | 12.50-14.50 |
| 1.4037 | X65Cr13 | 0.58-0.70 | 12.50-14.50 |
| 1.4057 | X17CrNi16-2/X19CrNi17-2 | 0.14-0.23 | 15.50-17.50 |
| 1.4104 | X12CrMoS17/X14CrMoS17 | 0.10-0.17 | 15.50-17.50 |
| 1.4108 | X30CrMoN15-1 | 0.25-0.35 | 14.00-16.00 |
| 1.4116 | X45CrMoV15/X50CrMoV15 | 0.45-0.55 | 14.00-15.00 |
| 1.4120 | X20CrMo13 | 0.17-0.22 | 12.00.14.00 |
| 1.4122 | X35CrMo17/X39CrMo17-1 | 0.33-0.45 | 15.50-17.50 |
| 1.4313 | X4CrNi13-4/X3CrNiMo13-4 | max. 0.05 | 12.50-14.00 |
| 1.4351 | X3CrNi13-4 | max. 0.04 | 12.70-14.80 |
| 1.4418 | X4CrNiMo16-5-1 | max. 0.05 | 15.00-16.50 |
| 1.4542 | X5CrNiCuNb16-4 | max. 0.07 | 15.00-17.00 |
| 1.4545 | X5CrNiCuNb15-5-4 | max. 0.07 | 14.00-15.50 |
| 1.4548 | X5CrNiCuNb17-4-4 | max. 0.07 | 15.00-17.50 |

The structural member concerned can, on the one hand, be a structural member of a gas exchange valve train of an internal combustion engine. By “gas exchange valve train” is to be understood the entirety of all structural members arranged in the internal combustion engine that are required for driving the gas exchange valve or valves. To name only a few examples, the structural members particularly referred to are:
the camshaft,
its connection to the crankshaft in the form of a chain drive including the chain guides and chain tensioners required for guiding and tensioning,
where used, a camshaft adjuster for adjusting the angular phase between the crankshaft and the camshaft,
the cam followers in operative contact with the cams of the camshaft either in the form of linearly mounted tappets such as a cup tappet actuating the gas exchange valve directly or a tappet actuating the gas exchange valve indirectly through a tappet push rod, or in the form of pivotable rocker arms, oscillating arms or finger levers with sliding or rolling cam contact comprising mechanically or hydraulically acting valve lash adjusters or compensation elements and
the pivot bearings required for supporting the pivotally mounted levers and typically provided in the form of common axles for the rocker arms or oscillating levers or in the form of individual support elements associated to each finger lever.

On the other hand, the structural member can also be a structural member of a mass balancing transmission for balancing free mass forces or torques of the internal combustion engine. To be particularly mentioned as an example in this case is a compensating shaft rotating at double the speed of a crankshaft for an internal combustion engine with a four-cylinder in-line design.

For establishing a clear connection of the above examples to the structural designs of the structural members known per se, reference may be made to the “Handbuch Verbrennungsmotor” (Handbook of internal combustion engines) 1st Edition, April 2002 published by Vieweg Verlag.

1. A structural member comprises of at least one component for an internal combustion piston engine operated with alcoholic fuel, at least one of the components being made of a martensitic with a C content of up to 0.7% and a Cr content of 12 to 18%, wherein in an installed state of the structural member in the internal combustion engine, the at least one component is directly exposed to lubricating oil serving to lubricate a crank mechanism of the internal combustion engine.

2. A structural member of claim 1, wherein the at least one component is made of one of the following steel materials selected from the group consisting of:
X45Cr13, X12CrS13, X10Cr13, X12Cr13, X20Cr13, X15Cr13, X30Cr13, X46Cr13, X65Cr13, X17CrNi16-2, X19CrNi17-2, X12CrMoS17, X14CrMoS17, X30CrMoN15-1, X45CrMoV15, X20CrMo13, X35CrMo17, X39CrMo17-1, X4CrNi13-4, X3CrNiMo13-4, X3CrNi13-4, X4CrNiMo16-5-1, X5CrNiCuNb16-4, X5CrNiCuNb15-5-4 and X5CrNiCuNb17-4-4.

3. A structural member of claim 1, wherein the structural member is a structural member of a gas exchange valve train of the internal combustion engine.

4. A structural member of claim 1, wherein the structural member is a structural member of a mass balancing transmission of the internal combustion engine.
